(19) United States
(12) Patent Application Publication
(10) Pub. No.: US 2014/0049608 A1
(43) Pub. Date: Feb. 20, 2014

(54) VIDEO PROCESSING DEVICE AND VIDEO PROCESSING METHOD

(71) Applicant: Panasonic Corporation, Osaka (JP)

(72) Inventors: Yuki MARUYAMA, Osaka (JP); Yuki KOBAYASHI, Osaka (JP); Kentaro Matsumoto, Osaka (JP); Yasunobu OGURA, Osaka (JP)

(73) Assignee: Panasonic Corporation, Osaka (JP)

(21) Appl. No.: 14/064,729

(22) Filed: Oct. 28, 2013

Related U.S. Application Data
(63) Continuation of application No. PCT/JP2012/005754, filed on Sep. 11, 2012.

(30) Foreign Application Priority Data
Jan. 18, 2012 (JP) 2012-007622

(51) Int. Cl. H04N 7/32; H04N 13/00

(52) U.S. Cl. CPC H04N 19/00769; H04N 13/0048
USPC 348/43

(57) ABSTRACT

A video processing device allows a viewer to suitably see an image in reproducing a compression coded stereoscopic image signal. A decoder decodes the compression coded signal of a stereoscopic image received as an input stream. A determiner evaluates a degree of a difference between a first viewpoint image and a second viewpoint image of the decoded stereoscopic image signal, and determines a display mode of the stereoscopic image signal based on the evaluation result. A picture generator generates an output image according to the determined display mode.

### CROSS-REFERENCE TO RELATED APPLICATIONS

This is a continuation of International Application No. PCT/JP2012/005754 filed on Sep. 11, 2012, which claims priority to Japanese Patent Application No. 2012-007622 filed on Jan. 18, 2012. The entire disclosures of these applications are incorporated by reference herein.

### BACKGROUND

The present disclosure relates to video processing techniques of reproducing compression coded signals of stereoscopic images.

Japanese Patent Publication No. H06-113334 shows an encoding device which calculates a quantization value so that the quantization value of the image is small at the front and great at the rear to reduce an information amount in encoding a stereoscopic image signal.

PCT International Publication No. WO 97/23097 shows a technique of creating a pair of image signals of a stereoscopic image from a conventional image signal and information on the depth of a subject contained in the image signal.

### SUMMARY

The present disclosure provides a video processing technique allowing a viewer to suitably see an image in reproducing a compression coded stereoscopic image signal.

A video processing technique according to the present disclosure, which reproduces a compression coded image signal of a stereoscopic image, includes decoding the compression coded signal into a stereoscopic image signal; evaluating a degree of a difference between a first viewpoint image and a second viewpoint image of the decoded stereoscopic image signal, and determining a display mode of the stereoscopic image signal based on the evaluation result; and generating an output image according to the determined display mode from the stereoscopic image signal.

In the present disclosure, the “degree of a difference between a first viewpoint image and a second viewpoint image” denotes an intrinsically undesired difference such as misalignment of the image in the vertical direction, a tilt difference, a difference in the sizes between right and left images other than displacement in the horizontal direction giving disparity for obtaining a stereoscopic effect.

The video processing device according to the present disclosure allows a viewer to suitably see an image in reproducing a compression coded stereoscopic image signal.

### BRIEF DESCRIPTION OF THE DRAWINGS

FIG. 1 illustrates the entire configuration of a recording device which is an example video processing device according to an embodiment.

FIG. 2 is a functional block diagram of a signal processor in the recording device of FIG. 1.

FIG. 3 is a flow chart illustrating example processing of decoding and displaying a compression coded image signal.

FIG. 4 illustrates an example program play list.

FIG. 5 is a flow chart illustrating example processing of determining the display mode of an image signal.

FIGS. 6A and 6B illustrate an example temporal change in right and left images of a decoded stereoscopic image signal.

FIG. 7 is a flow chart illustrating example processing of determining the display mode of an image signal.

FIG. 8 is example display of a sign recommending a user to switch to 2D image output.

FIG. 9 illustrates another example configuration of a video processing device.

### DETAILED DESCRIPTION

In encoding a moving picture, an information amount is generally compressed by reducing redundancy in a temporal direction and in a spatial direction. In interframe prediction encoding for reducing the temporal redundancy, a motion amount is detected in each block, which is one of a plurality regions divided from a picture, with reference to the previous or following frame in the temporal axis. Then, prediction (motion compensation) is performed in view of the detected motion vector. This increases prediction accuracy and improves encoding efficiency.

A picture not subjected to interframe prediction encoding, but only to intra-frame prediction encoding for reducing the spatial redundancy is called an I-picture. A picture subjected to interframe prediction encoding from a single reference picture is called a P-picture. A picture subjected to interframe prediction encoding from at maximum two reference pictures is called a B-picture. The term “picture” denotes a single frame.

Conventionally, various modes have been suggested for encoding 3D images, which are images for stereoscopic vision. A 3D image (i.e., a stereoscopic image) signal here denotes an image signal including an image signal in first viewpoint (i.e., a first viewpoint image signal) and an image signal in a second viewpoint different from the first viewpoint (i.e., a second viewpoint image signal). One of the first viewpoint image and the second viewpoint image is a right-eye image, and the other is a left-eye image. An image signal which is only the first viewpoint image signal or the second viewpoint image signal, is referred to as a 2D image signal.

An example mode for encoding a 3D image signal is as follows. A first viewpoint image signal is encoded by a conventional 2D image mode. A second viewpoint image signal is encoded by a mode using interframe prediction encoding with a picture of the first viewpoint image signal at the same time used as a reference picture.

Another example is as follows. The sizes of a first viewpoint image signal and a second viewpoint image signal are horizontally reduced to ½, and the reduced image signals are horizontally arranged. Then, the image signals are encoded by the same mode as the 2D image mode. In this case, information indicating that the image is a 3D image is added as header information on an encoded stream. This distinguishes the encoded 3D image stream from an encoded 2D image stream.

When a stereoscopic image signal includes an intrinsically undesired difference such as misalignment of an image in the vertical direction, a tilt difference, and a difference in size between right and left images, a viewer may feel cognitive inconsistency. The viewer feels uncomfortable to see such a stereoscopic image. The present disclosure provides a video processing technique addressing the problem.

An Embodiment is described in detail below with reference to the attached drawings. However, unnecessarily detailed description may be omitted. For example, detailed description of well-known techniques or description of the substantially same elements may be omitted. Such omission is intended to prevent the following description from being unnecessarily redundant and to help those skilled in the art easily understand it.

The inventors provide the following description and the attached drawings to enable those skilled in the art to fully understand the present disclosure. Thus, the description and the drawings are not intended to limit the scope of the subject matter defined in the claims.

### First Embodiment

Compression distortion is one of the causes of the above-described intrinsically undesired difference between right and left images. The compression distortion occurs in compression coding of a stereoscopic image signal. The right-eye image and the left-eye image forming the stereoscopic image are shifted from each other in advance in the horizontal direction to provide a disparity for obtaining stereoscopic effect. Thus, what is shown by the right-eye image is not completely identical to what is shown by the left-eye image, and temporal changes are different. Therefore, what is processed in intra-frame prediction encoding and interframe prediction encoding of compression coding is different between the right and left images. As a result, distortion occurs in the decoded right and left images. For example, block noise, mosquito noise, etc. appear in different positions, ranges, and sizes between the right and left images, thereby allowing a viewer to recognize the distortion.

If a relatively small amount of information is generated in compression coding, specifically, if a signal is output at a low bit rate, the above-described “distortion” appears and has a great influence. This is because, where the recording rate is low, the amount of information lacking due to the compression coding increases, thereby increasing the difference between the image signal at the time of decoding and the original image signal. With an increase in the difference, the difference between the decoded right and left images is considered to increase as well. On the other hand, with an increase in the recording rate, the amount of the lacking information decreases, thereby reducing the difference between the decoded right and left images.

In this embodiment, the degree of the influence of the compression distortion on the stereoscopic image signal is used as an index indicating the difference between the right and left images. The degree of the influence of the compression distortion is evaluated using encoding information such as a quantization width in compression coding. The display mode of the stereoscopic image signal is determined based on the evaluation result.

### 1.1 Recording Device

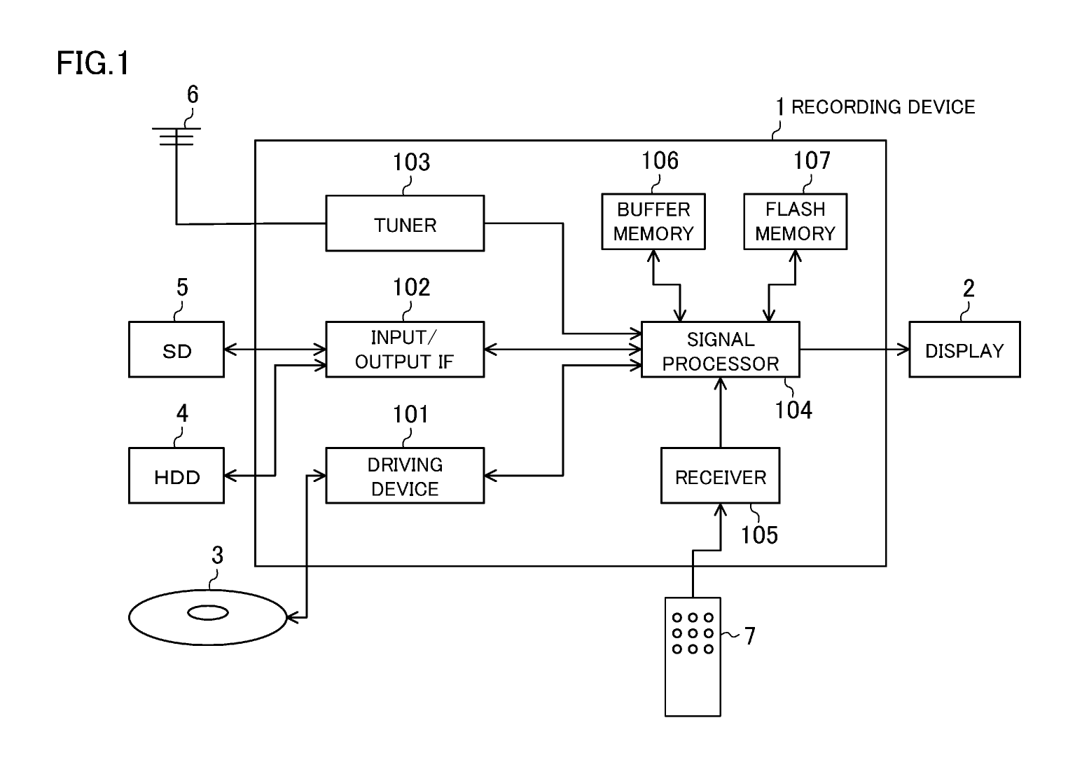

FIG. 1 illustrates the functional configuration of a recording device 1 for recoding video as an example video processing device. The recording device 1 is coupled to a display 2, a BD disk 3, an HDD device 4, an SD card 5, an antenna 6, a remote controller 7, etc.

The display 2 is a device for displaying the image reproduced by the recording device 1. The BD disk 3, the SD card 5, and the HDD device 4 are recoding media recording image data reproduced/recorded etc. by the recording device 1. The antenna 6 is a device receiving a video program delivered from a transfer station through broadcast waves. The remote controller 7 receives an instruction from a user of the recording device 1, and sends the instruction to the recording device 1.

The recording device 1 includes a driving device 101, an input/output IF 102, a tuner 103, a signal processor 104, a receiver 105, a buffer memory 106, and a flash memory 107.

The driving device 101 includes a disk tray, and reads an image signal from the BD disk 3 contained in the disk tray. Where an image signal is input from the signal processor 104, which will be described later, the image signal is written in the BD disk 3 contained in the disk tray.

The input/output IF 102 is a coupling interface for inputting/outputting data to/from the HDD device 4 and the SD card 5. The input/output IF 102 sends and receives a control signals and an image signal between the HDD device 4 or the SD card 5, and the signal processor 104. The input/output IF 102 sends an input stream input from the HDD device 4 or the SD card 5 to the signal processor 104. The input/output IF 102 sends an encoded stream or an uncompressed video stream, which is input from the signal processor 104, to the HDD device 4 and the SD card 5. For example, the input/output IF 102 is an HDMI connector, an SD card slot, an USB connector, etc.

The tuner 103 receives the broadcast waves received by the antenna 6. The tuner 103 sends an image signal with a specific frequency designated by the signal processor 104 to the signal processor 104. As a result, the signal processor 104 processes the image signal with the specific frequency, which is contained in the broadcast waves.

The driving device 101, the input/output IF 102, and the tuner 103 according to this embodiment obtain at least a stereoscopic image signal. The driving device 101, the input/output IF 102, and the tuner 103 output the obtained stereoscopic image signal to the signal processor 104. The signal output to the signal processor 104 is hereinafter referred to as an input stream. The input stream is the above-described stereoscopic image signal or a conventional image (i.e., a 2D image) signal.

The stereoscopic image signal here denotes a pair of right and left images used in stereoscopic view in the display 2. For example, the stereoscopic image signal may include a first viewpoint image signal and a second viewpoint image signal. The image for stereoscopic vision may be a stream encoded based on multi view coding (MVC). The first viewpoint image signal and the second viewpoint image signal may arrange side by side or top and bottom.

The signal processor 104 controls each part of the recording device 1. In addition, the signal processor 104 has a function of decoding and encoding the image signal output from the input/output IF 102, the driving device 101, and the tuner 103. The signal processor 104 decodes a compression coded input stream under an encoding standard such as H.264/AVC, MPEG2, etc. The decoded image signal is displayed by the display 2, or recorded on the BD disk 3, the HDD device 4, the SD card 5, etc.

The signal processor 104 also performs compression coding of an input stream under the encoding standard such as H.264/AVC, MPEG2, etc. The processing of the signal processor 104 is not limited to the above-described compression modes, and another mode may be utilized. The compression coded image signal is recorded on the BD disk 3, the HDD device 4, the SD card 5, etc. The specific configuration and processing etc., of the signal processor 104 will be described later. The signal processor 104 may be a microcomputer, or a hard-wired circuit.

The receiver 105 receives a control signal from the remote controller 7 and sends the control signal to the signal processor 104. The receiver 105 may be, for example, an infrared sensor. The buffer memory 106 is used as a working memory when the signal processor 104 performs signal processing. The buffer memory 106 may be, for example, a DRAM. The flash memory 107 stores a program, etc. executed by the signal processor 104. The flash memory 107 may be a NAND non-volatile memory etc.

### 1-2. Signal Processor 104

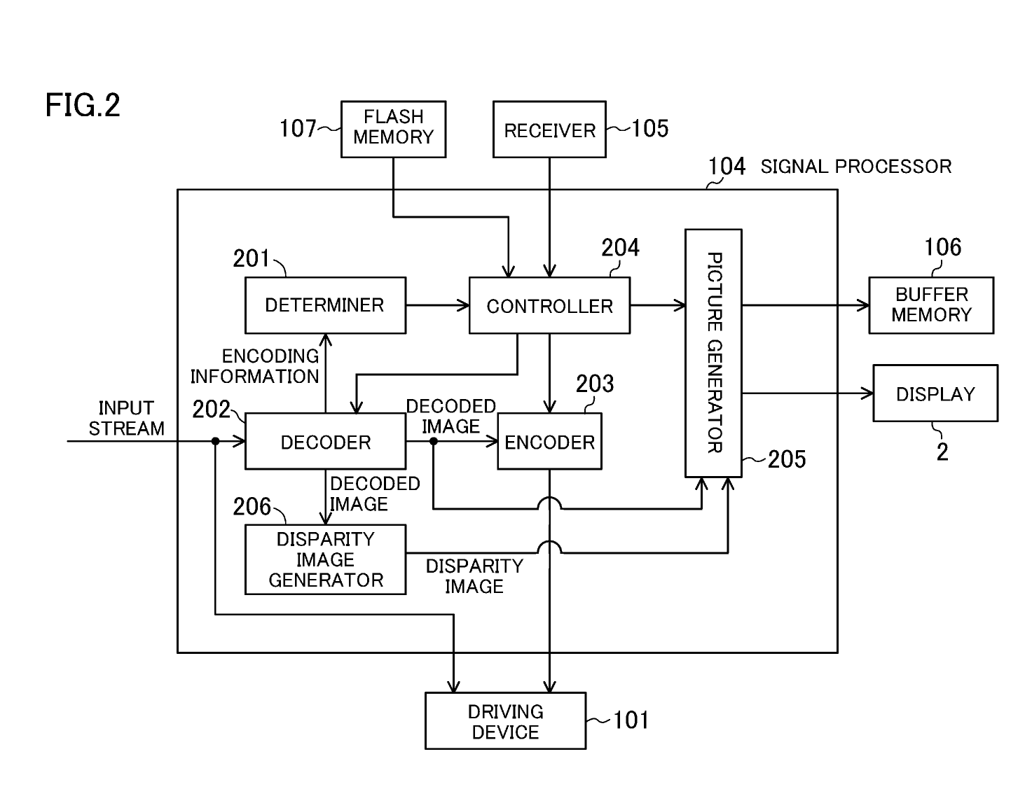

FIG. 2 is a block diagram illustrating the functional configuration of the signal processor 104. The signal processor 104 includes a determiner 201, a decoder 202, an encoder 203, a controller 204, a picture generator 205, and a disparity image generator 206.

The decoder 202 decodes an input stream, which has been compression coded, based on control information on the controller 204 to obtain a decoded image and encoding information. The decoder 202 outputs the obtained decoded image to the picture generator 205 and the disparity image generator 206, and the obtained encoding information to the determiner 201.

The encoding information here denotes information such as various parameters required in the compression coding of the compression coded image signal. Specifically, header information containing the quantization width used in encoding the input stream, and information such as the recording mode, the data amount, and the recording time. That is, the encoding information denotes information related to the encoding of the input stream.

The encoder 203 performs further compression coding of the decoded image generated by the decoder 202 based on the control information on the controller 204. For example, the encoder 203 performs compression coding in the compression mode and at the recording rate, which are notified by the controller 204. The encoder 203 records the obtained compression coded image signal on any one of the BD disk 3, the HDD device 4, the SD card 5, etc. FIG. 2 illustrates the data flow when the encoder 203 records the compression coded image signal on the BD disk 3 via the driving device 101. In addition to the compression coded image signal, the management information such as the recording mode, the data amount, the play time, the program information, which is employed in the compression coding, is also recorded at the same time.

The user may select to which of the BD disk 3, the HDD device 4, or the SD card 5 the compression coded image signal is to be recorded via the remote controller 7. Where the encoder 203 receives the recording condition of not performing compression coding, the decoded image is recorded without change on the BD disk 3, the HDD device 4, or the SD card 5.

The disparity image generator 206 calculates disparity information between the right and left images forming the stereoscopic image signal based on the decoded image received from the decoder 202. The disparity image generator 206 generates from the calculated disparity information, and the image signal of one of the right and left images forming the stereoscopic image signal, a disparity image signal as the other image signal of the stereoscopic image signal. The disparity image generator 206 outputs the disparity image signal to the picture generator 205.

The determiner 201 determines the mode of the image output from the picture generator 205, i.e., the display mode of the stereoscopic image signal. Specifically, for example, the determiner 201 selects any one of the plurality of modes of (1) outputting the image decoded by the decoder 202, (2) outputting a corrected image using the disparity image signal, or (3) outputting a normal 2D image, based on the encoding information output from the decoder 202. Then, the determiner 201 outputs the control signal indicating the determined mode to the controller 204. Specific operation of the determiner 201 will be described later.

The controller 204 controls the operation of the entire signal processor 104. The controller 204 sets the display mode of the stereoscopic image signal to the encoder 203 and the picture generator 205 based on the control signal from the determiner 201, or based on the selection of the user using the remote controller 7 via the receiver 105. Where the mode determined by the determiner 201 is different from the mode selected by the remote controller 7, the controller 204 may preferentially select, for example, the selection sent by the remote controller 7.

The picture generator 205 generates a picture output to and displayed on the display 2 based on the control information on the controller 204. Upon receipt of the instruction of the controller 204 to (1) output the decoded image, the picture generator 205 outputs the right and left image signals of the decoded stereoscopic image signal to the display 2. Upon receipt of the instruction of the controller 204 to (2) output the corrected image, the picture generator 205 outputs to the display 2, a stereoscopic image signal including one of the right and left image signals forming the decoded stereoscopic image signal, and the disparity image signal generated by the disparity image generator 206 from the one of the right and left image signals. Upon receipt of the instruction of the controller 204 to (3) output the 2D image, the picture generator 205 outputs to the display 2, only one of the right and left image signals contained in the stereoscopic image signal decoded by the decoder 202.

### 1-3. Control Flow

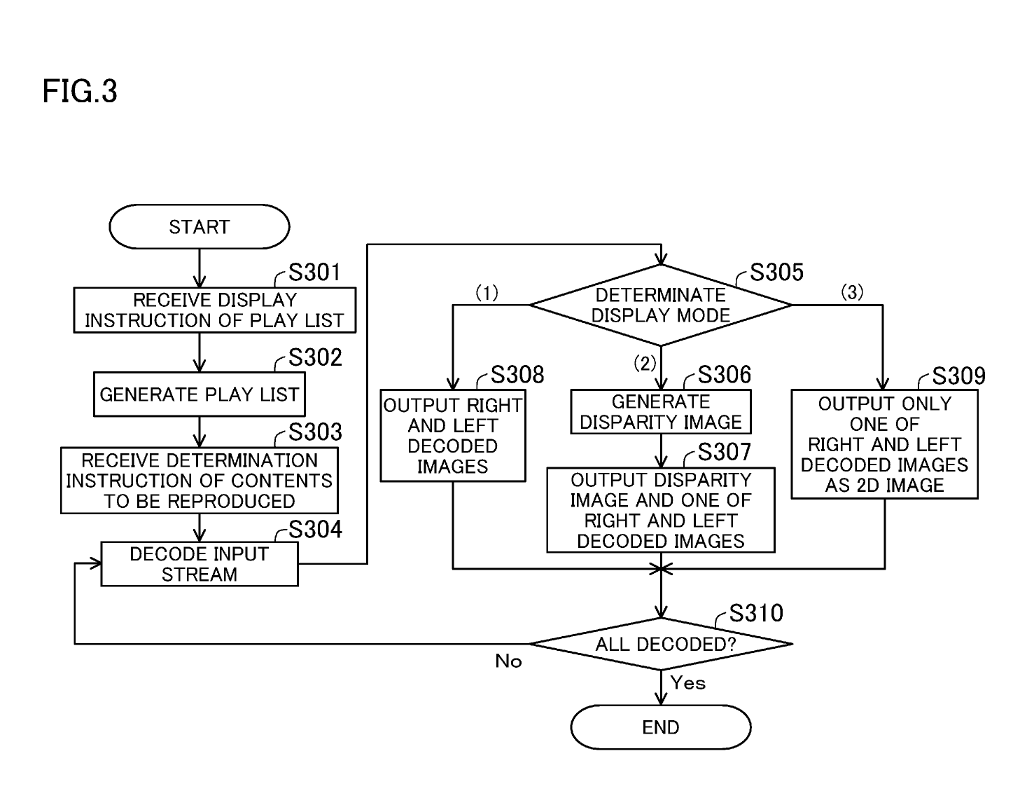

FIG. 3 is a flow chart illustrating example processing where the signal processor 104 decodes and displays a compression coded image signal.

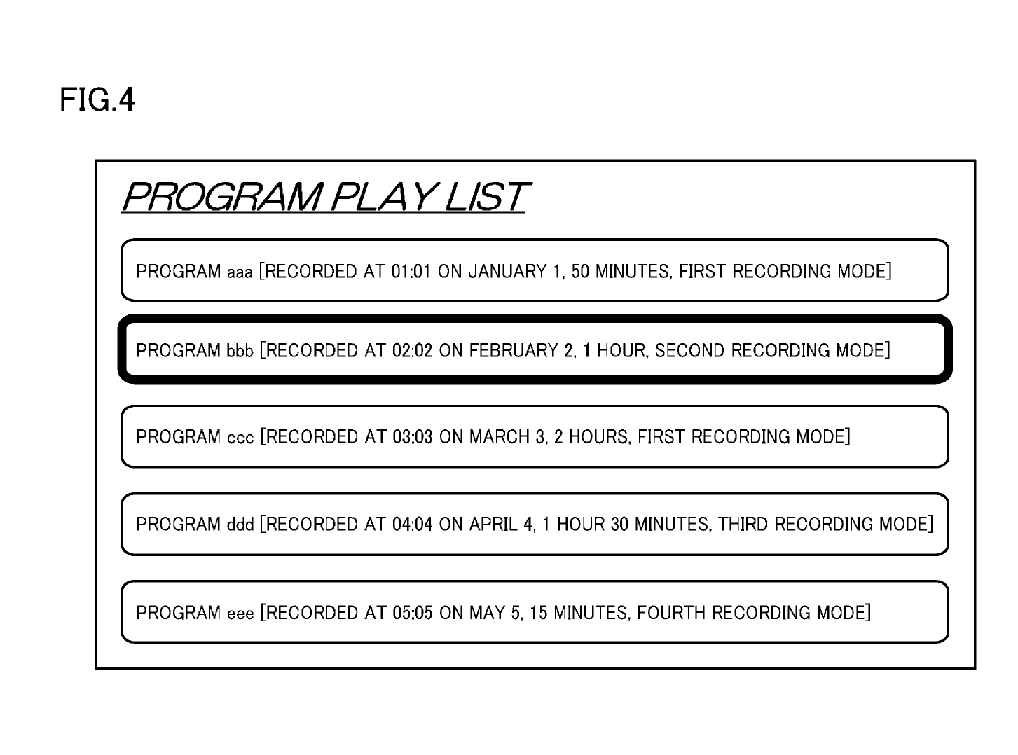

When the user sends an instruction to the recording device 1 using the remote controller 7, the recording device 1 receives the instruction at the receiver 105, and notifies the received result to the signal processor 104. Where the instruction is to display a play list, which is the instruction to display a list of video contents managed by the recording device 1 (step S301), the controller 204 instructs the picture generator 205 to display the play list. The picture generator 205 displays a playable program list shown in FIG. 4 (step S302).

The controller 204 receives information indicating video contents, which is the target of play selected by the user (step S303). The controller 204 selects a source (herein the tuner 103, the BD disk 3, the HDD device 4, or the SD card 5) onto which the video contents indicated by the received information are recorded or delivered, and reads the contents (i.e., the compression coded stereoscopic image signal). The read stereoscopic image signal is decoded by the decoder 202 (step S304). The decoder 202 does not decode the entire input stream, but generates the decoded image required for outputting a picture to the display 2. Then, the process moves to the next step S305.

The determiner 201 obtains the encoding information from the decoder 202, and determines the display mode of the output image based on the obtained encoding information (step S305). The determiner 201 here determines any one of (1) outputting the decoded image, (2) outputting the corrected image, or (3) outputting the 2D image. The signal processor 104 shifts the control to step S308 where the mode (1) is selected, to step S306 where the mode (2) is selected, and to step S309 where the mode (3) is selected. How to determine the display mode based on the encoding information will be described later.

In the step S308, the controller 204 notifies the determination of the determiner 201, i.e., to select the mode (1) to the picture generator 205. The picture generator 205 outputs the right and left image signals of the stereoscopic image signal decoded by the decoder 202 to the display 2.

In the step S306, the disparity image generator 206 generates a disparity image from one of the image signals of the stereoscopic image signal. At this time, the determiner 201 may determine, based on the encoding information, which of the right and left image signals of the decoded stereoscopic image signal is used as a basis. For example, assume that the compression coded stereoscopic image signal may contain the left-eye image signal as the basis, and the right-eye image signal is compression coded with reference to the left-eye image signal. The disparity image generator 206 preferably generates the disparity image signal from the left-eye image signal used as the basis. As a result, a more reliable stereoscopic image signal is provided as compared to the case where the right-eye image signal is used as the basis. The detail of the disparity image generator 206 will be described later.

In the step S307, the controller 204 notifies the determination by the determiner 201, i.e., to select the mode (2) to the picture generator 205. The picture generator 205 outputs to the display 2, the stereoscopic image signal including one of the image signals of the stereoscopic image signal decoded by the decoder 202 and the disparity image signal input from the disparity image generator 206.

On the other hand, in the step S309, the controller 204 notifies the determination of the determiner 201, i.e., to select the mode (3) to the picture generator 205. The picture generator 205 outputs to the display 2, only one of the right and left image signals of the stereoscopic image signal decoded by the decoder 202. In this case, the display 2 displays the image signal two-dimensionally.

The controller 204 determines whether or not all the selected video contents have been decoded and displayed (step S310). Where the contents are all decoded, the process ends. Where the decoding is incomplete, the process goes back to the step S304 and the above-described process is repeated.

### 1-4. Determination by Determiner 201

The determiner 201 indirectly measures the degree of the influence of compression distortion on the decoded stereoscopic image signal based on the encoding information received by the decoder 202. Then, the determiner 201 determines the display mode of the stereoscopic image signal using the degree of the influence of the compression distortion as the index indicating the difference between the right and left images of the decoded stereoscopic image signal. The degree of the influence of the compression distortion represents the degree of the difference between the right and left images. Specifically, it is assumed that there is a small difference between the right and left images where the compression distortion has a small influence and a great difference between the right and left images, where the compression distortion has a great influence.

As described above, the “compression distortion” depends on the difference between the pictures of the right and left images in the compression coding of the stereoscopic image signal, or the difference between reference pictures in interframe prediction encoding. Thus, the degree of the influence of the compression distortion on the decoded stereoscopic image signal depends on the condition of the compression coding. Thus, in this embodiment, the degree of the influence of the compression distortion is evaluated using the information on the quantization width in the compression coding, which is contained in the encoding information.

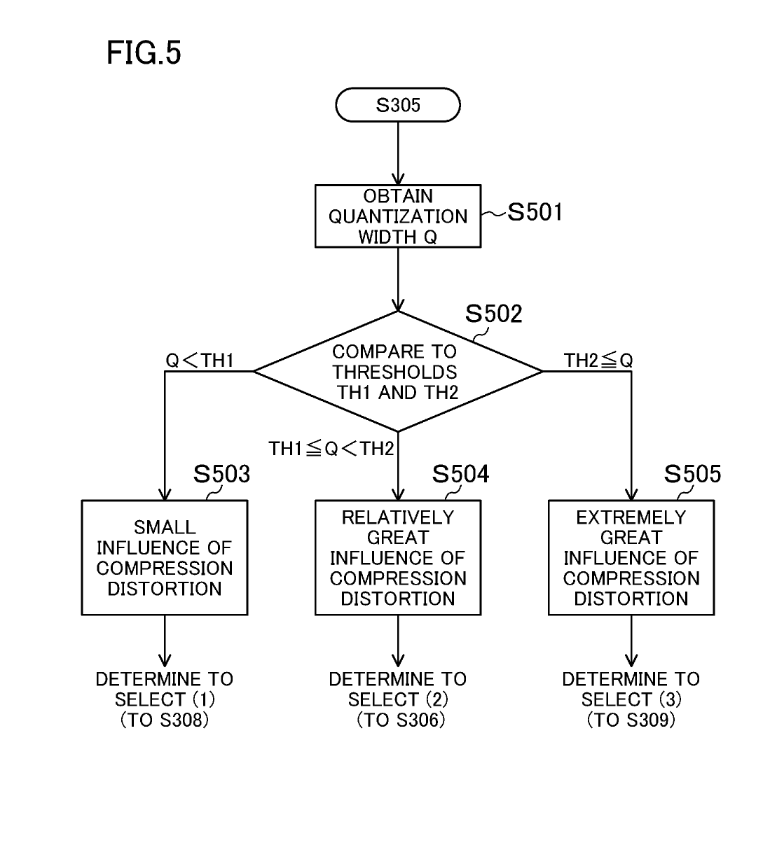

FIG. 5 is a flow chart illustrating example processing in the step S305 of FIG. 3, i.e., the determination of the determiner 201 on the display mode of the output image.

First, in a step S501, information on a quantization width Q is obtained from the encoding information received from the decoder 202. In this embodiment, the quantization width of the frame to be decoded is used. For example, the information on a reference quantization width, which is given to each frame, may be used. Where the input stream is compression coded under H.264/AVC encoding standard, the quantization width may be calculated from a QP value or a quantization matrix.

Next, in a step S502, the quantization width Q obtained in the step S501 is compared to predetermined first and second thresholds TH1 and TH2, where TH1<TH2.

Where Q<TH1, i.e., where the quantization width Q obtained from the encoding information is smaller than the first threshold TH1, the influence of the compression distortion is determined to be small (S503). In this case, the stereoscopic image signal decoded by the decoder 202 is less influenced by the compression distortion. Thus, the viewer suitably enjoys the image in seeing the decoded stereoscopic image signal without change. The determiner 201 determines to (1) output the decoded image.

Where TH1≦Q<TH2, i.e., where the quantization width Q obtained from the encoding information is greater than or equal to the first threshold TH1 and smaller than the second threshold TH2, the influence of the compression distortion is determined to be relatively great. The determiner 201 determines to (2) output the corrected image. As a result, the stereoscopic image displayed on the display 2 contains a decoded first viewpoint image, and a second viewpoint image generated using the first viewpoint image as a basis. Thus, the correlation between the right and left images is extremely high, thereby reducing discomfort in seeing the image. Accordingly, the viewer suitably sees a more natural stereoscopic image.

Where TH2≦Q, i.e., where the quantization width Q obtained from the encoding information is greater than or equal to the second threshold TH2, the influence of the compression distortion on the stereoscopic image signal decoded by the decoder 202 is determined to be extremely great. The determiner 201 determines to (3) output the 2D image. As a result, since no stereoscopic image is output to the display 2 and the display 2 displays a 2D image, the influence of the compression distortion caused by the unbalance between right and left images of the stereoscopic image does not appear on the displayed image. This prevents the viewer from seeing an unnatural stereoscopic image.

While in this embodiment, the quantization width of the frame to be decoded is used, the present disclosure is not limited thereto. For example, the quantization width of an I-picture decoded immediately before the frame to be decoded may be used. Alternatively, statistical processing of the quantization widths of one or more of the decoded frames may performed, and the result may be used. The statistical processing may be performed using, for example, an average, a histogram, etc. The statistical processing may be independently performed for I-pictures, P-pictures, B-pictures, and the results may be used.

The quantization width per block may be used. For example, since information on a reference quantization width is given to each frame, and the difference from the reference quantization width is given to each block, the information may be used.

The quantization width for determining the display mode may be updated periodically, e.g., at intervals of a few seconds. For example, at 30 frames/second, the quantization width may be updated in every 15 frames (i.e., 0.5 seconds). In this case, for example, in a most common picture alignment “BBIBBPBBPBBPBBP,” the quantization width of the I-picture may be used, or the average quantization width between the I-picture and the P-pictures may be used.

The degree of the influence of the compression distortion may be evaluated based on information other than the quantization width. For example, another determination index may be information on the recording rate. The recording rate is the average bit rate of the compression coded image signal. For example, where contained in the encoding information, the recording rate may be obtained therefrom. Alternatively, the recording rate may be obtained from the data amount and the recording time of the compression coded image signal, or may be obtained from information on the recording mode. The influence of the compression distortion is evaluated to be small where the recording rate is high, and great where the recording rate is low. For example, the determination may be made by comparing the recording rate to two thresholds and selecting any one of (1) outputting the decoded image, (2) outputting the corrected image, or (3) outputting the 2D image, similar to the example using the quantization width.

### 1-5. Operation of Disparity Image Generator 206

The disparity image generator 206 generates the disparity information on the decoded image based on the decoded image signal received from the decoder 202. The processing of obtaining the disparity information is generally called “stereo matching.” For example, the amount of the horizontal movement may be detected in each block, which is divided from a picture region, from one of the right and left images forming the stereoscopic image with reference to the other one of the right and left images. Then, the movement of each detected block is obtained as the disparity information. The movement may be detected by, for example, block matching using the sum of absolute difference (SAD) in pixel between a block to be processed and a reference block.

Then, the disparity image generator 206 generates the disparity image signal based on the decoded image signal received from the decoder 202 and the generated disparity information. The disparity image signal may be generated by, for example, depth image based rendering (DIBR) shown in PCT International Publication No. WO 97/23097.

### 1-6. Advantages Etc.

As described above, the recording device 1 shown in this embodiment determines whether or not the decoded image can be seen as a stereoscopically comfortable 3D image based on the information such as the quantization width and the recording rate contained in the encoding information in reproducing the compression coded image signal. In the determination that the decoded stereoscopic image cannot be seen suitably, the recording device 1 further determines to correct the image to a suitable stereoscopic image, or output the stereoscopic image as a 2D image.

In this embodiment, the display mode of the image is changed based on the compression coding condition of the stereoscopic image signal, thereby allowing the viewer to see a suitable image. More specifically, the recording device 1 suitably switches among the modes of (1) outputting the decoded image, (2) outputting the corrected image, and (3) outputting the 2D image in accordance with the degree of the influence of the “compression distortion” in the compression coding of the stereoscopic image signal. This allows the viewer to suitably see a stereoscopic image without feeling discomfort caused by the compression distortion.

While in this embodiment, an example has been described where the information on the quantization width and the recording rate is used to evaluate the degree of the influence of the compression distortion, the present disclosure is not limited thereto. Another example of available information may be information on setting the filtering degree of a deblocking filter, and on the ratio of the number of the blocks subjected to intra-frame prediction to the number of the blocks subjected to inter frame prediction (i.e., the ratio of the intra/inter frame prediction blocks); and the statistical information on the motion vector; which are contained in the encoding information.

The information on setting the filtering degree of the deblocking filter is contained in the stream. Setting a high filtering degree (i.e., a great coefficient) means that there is a need to filter more finely. In this case, the quantization width is great, and it is thus highly possible that the compression distortion has a great influence. When the object moves quickly in the image, the intra-frame prediction tends to be used more, thereby increasing the ratio of the intra/inter frame prediction blocks. When the image moves quickly, there is a need to increase the quantization width to maintain the recording rate. Therefore, when the ratio of intra/inter frame prediction blocks is high, the influence of the compression distortion is predicted to be great. The value of the statistical information on the motion vector also increases when the object moves quickly in the image. When the image moves quickly, there is a need to increase the quantization width to maintain the recording rate. Therefore, when the statistical information on the motion vector has a great value, the influence of the compression distortion is predicted to be great.

As described above, the degree of the influence of the compression distortion in the stereoscopic image signal may be evaluated using not only the quantization width or the recording rate, but also the information on setting the filtering degree of the deblocking filter, the ratio of the intra/inter frame prediction blocks, or the statistical information on the motion vector. Alternatively, two or more of these indexes may be used in combination.

### Second Embodiment

In the first embodiment, an example has been described where the mode of the output image is switched based on the encoding information on the stereoscopic image to be decoded. In this second embodiment, an example will be described where the mode of an output image is switched based on other information. In this embodiment, differences from the first embodiment will be mainly explained, and repetitive explanation of substantially the same configuration may be omitted.

### 2-1. Operation

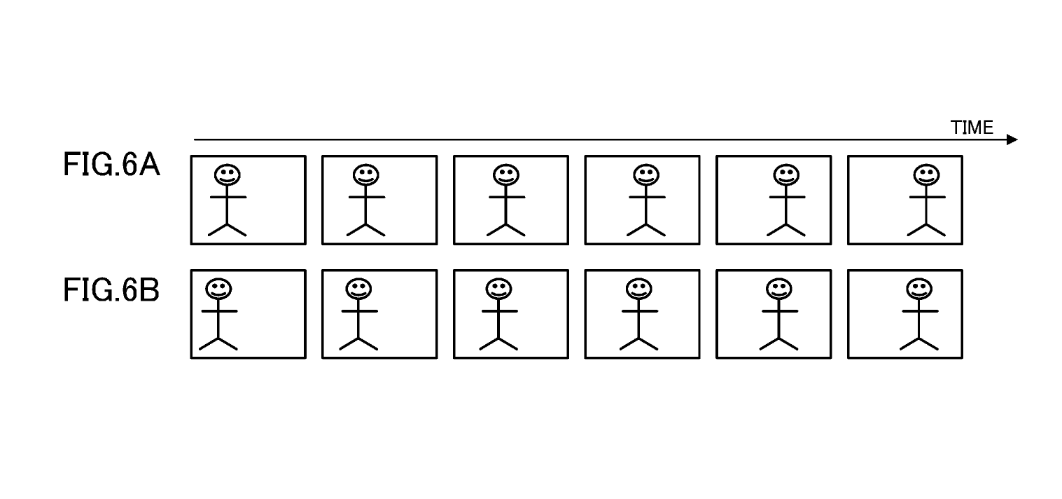

FIGS. 6A and 6B illustrate an example temporal change of right and left images of a decoded stereoscopic image signal. FIG. 6A represents the left-eye image of the stereoscopic image, and FIG. 6B represents the right-eye image of the stereoscopic image. In this embodiment, a determiner 201 receives the stereoscopic image signal actually decoded at a decoder 202, and compares the right-eye image to the light-eye image to evaluate the difference therebetween. Then, the determiner 201 determines the display mode of the stereoscopic image signal based on the evaluation result.

For example, an index is used, whose value increases with an increase in the difference between the right and left images. Where the value of the index is smaller than a first threshold, the determiner 201 determines to output the decoded stereoscopic image signal without change. Where the value of the index is greater than or equal to the first threshold and smaller than the second threshold, the determiner 201 determines to generate a disparity image from one of the right and left images of the decoded stereoscopic image signal, and to output the generated disparity image and the original one of the right and left images. Where the value of the index is greater than or equal to the second threshold, the determiner 201 determines to output only one of the right and left images of the decoded stereoscopic image signal as a 2D image.

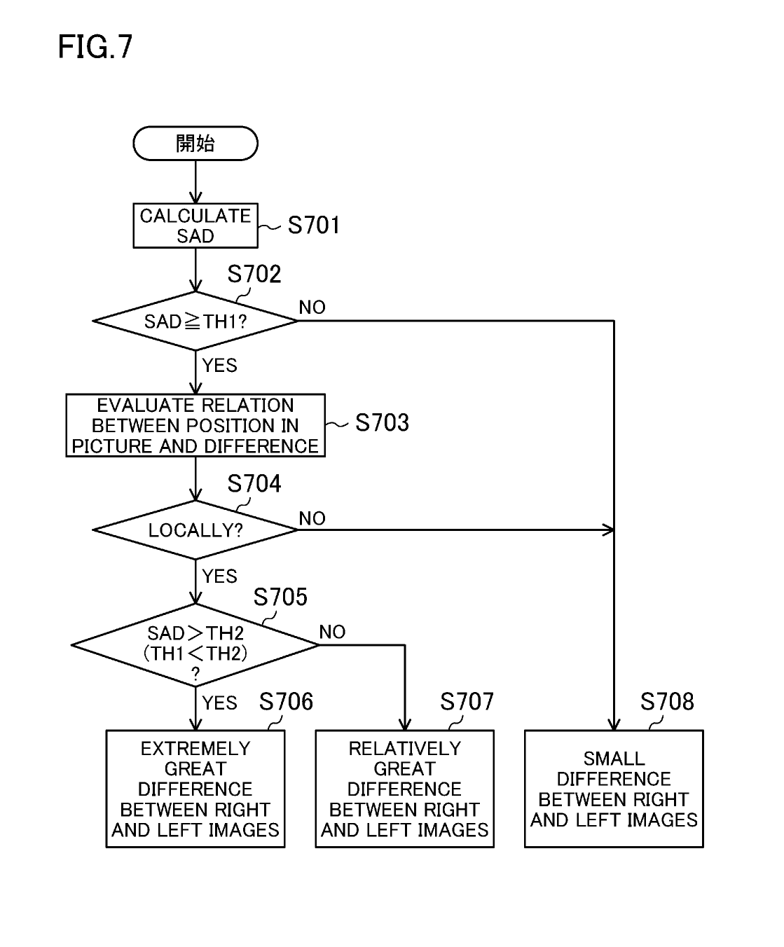

FIG. 7 is a flow chart illustrating example processing of determining the display mode of the image signal. First, the sum of absolute difference (SAD) between the right and left images of the stereoscopic image signal is calculated (S701). Where the value of the calculated SAD is smaller than the first threshold TH1 (NO in S702), the determiner 201 determines that the difference between the right and left images is small, and to output the decoded stereoscopic image signal without change (S708).

On the other hand, where the value of the calculated SAD is greater than or equal to the first threshold TH1 (YES in S702), the relation between the position in the picture and the difference is evaluated (S703). Where the difference is almost uniform in the picture (NO in S704), the determiner 201 determines that the difference between the right and left images is small, and to output the decoded stereoscopic image signal without change (S708). On the other hand, where the difference distributes locally (YES in S704), the difference between the right and left images is considered great, and thus the value of the calculated SAD is compared to the second threshold TH2, where TH2>TH1 (S705).

Where the value of the calculated SAD is greater than the second threshold TH2 (YES in S705), the determiner 201 determines that the difference between the right and left images is extremely great, and to output only one of the right and left images of the decoded stereoscopic image signal as a 2D image (S706). On the other hand, where the value of the calculated SAD is smaller than or equal to the second threshold TH2 (NO in S705), the determiner 201 determines that the difference between the right and left images is relatively great, and to output the generated disparity image and one of the images of the stereoscopic image (S707).

### 2-2. Advantages

In this embodiment, the difference between the right and left images is evaluated by comparing the actually decoded right and left images. This method makes the evaluation of the difference between the right and left images more accurate than the method for detecting the compression distortion based on the encoding information described in the first embodiment. This embodiment also allows a viewer to suitably see a stereoscopic image with little discomfort caused by compression distortion in reproducing a compression coded image signal.

In this embodiment, not only the compression distortion caused by the compression coding, but also image distortion due to an optical factor such as lens can be evaluated. Therefore, a stereoscopic image can be provided with little discomfort caused by the distortion.

### Other Embodiments

As described above, the first and second embodiments have been described as example techniques disclosed in the present application. However, the techniques according to the present disclosure are not limited to these embodiments, but are also applicable to those where modifications, substitutions, additions, and omissions are made. In addition, elements described in the first and second embodiments may be combined to provide a different embodiment.

The other embodiments will be described below.

While in the above-described embodiments, the display mode of the stereoscopic image signal is suitably switched among the three cases of (1) outputting the decoded image, (2) outputting the corrected image, and (3) outputting the 2D image, the present disclosure is not limited thereto. For example, the mode may be suitably switched between two cases of (1) outputting the decoded image, and (2) outputting the corrected image. This always provides display of a stereoscopic image signal, thereby allowing the viewer to suitably see a stereoscopic image. In this case, a single threshold may be used to switch between the cases (1) and (2).

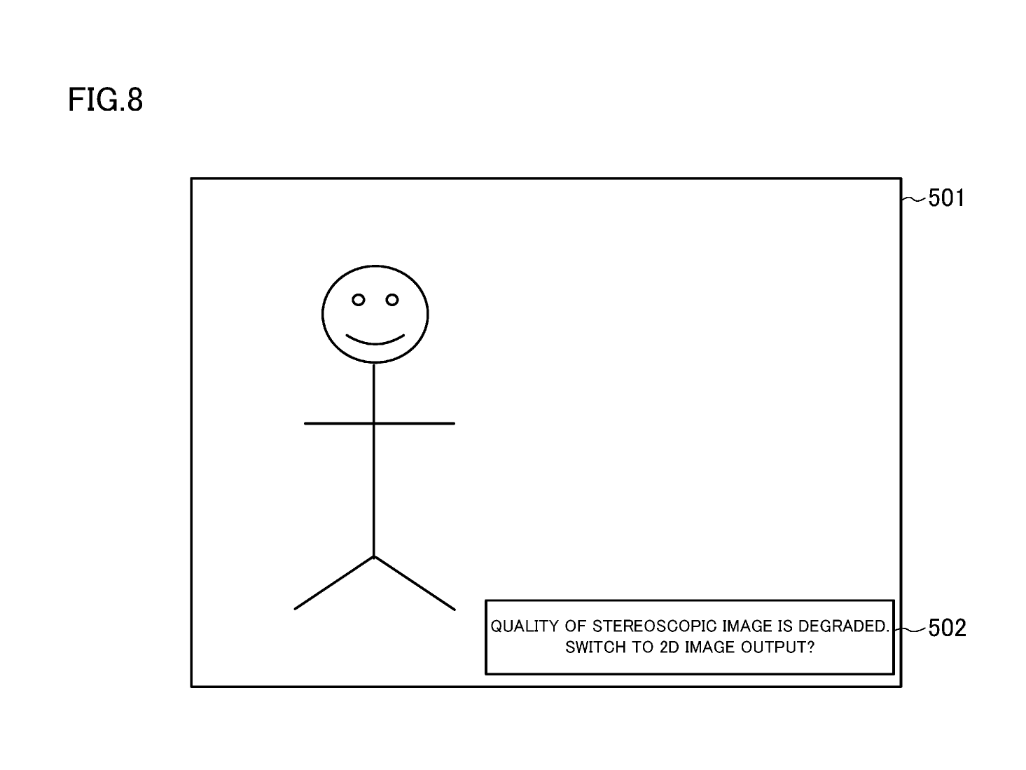

While in the above-described embodiments, the signal processor 104 suitably automatically switches among the three cases. The switching may also be controlled by the user. For example, in the determination that the difference between the right and left images of the stereoscopic image signal to be decoded is extremely great, the recording device 1 (i.e., the signal processor 104) outputs, as shown in FIG. 8, a sign 502 recommending switch to 2D image is output at the bottom right of a display screen 501. Where the user instructed to switch the mode to the 2D image output using the remote controller 7 in response to the recommendation, the signal processor 104 switches the mode to (3) outputting a 2D image. As a result, the user prevents unexpected switching to the 2D-image output. In this case, the switching between (1) and (2) is automatically performed by the signal processor 104, and the switching between (2) and (3) is performed when the user acknowledges. The sign recommending switching is not limited to what is shown in FIG. 8. Switching may be recommended to the user by a means other than the display of the sign, for example, a sound.

The determiner 201 may determine the display mode of the image when the scenes of the stereoscopic image change. A change in the scenes may be detected by, for example, determining whether or not the SAD between a target frame and a frame immediately before the target is greater than or equal to a threshold. The display timing of an I-picture may be regarded as a change in the scenes. Alternatively, where the scene change can be detected as described above and the I-picture appears, the display mode of the image may be determined. Since these means switch the display mode of the image when what is displayed changes, or at similar timing, the viewer hardly recognizes the discomfort caused by the change in the display mode.

While in the above-described embodiments, an example has been described where the output of the stereoscopic image signal is displayed on the display 2, the present disclosure is not limited thereto. For example, the image whose display mode is changed suitably may be recorded on the BD disk 3, the HDD device 4, the SD card 5, etc. This enables recording of an image signal whose suitable display mode is determined. There is thus no need to repeat the process described in the embodiments in subsequent reproduction.

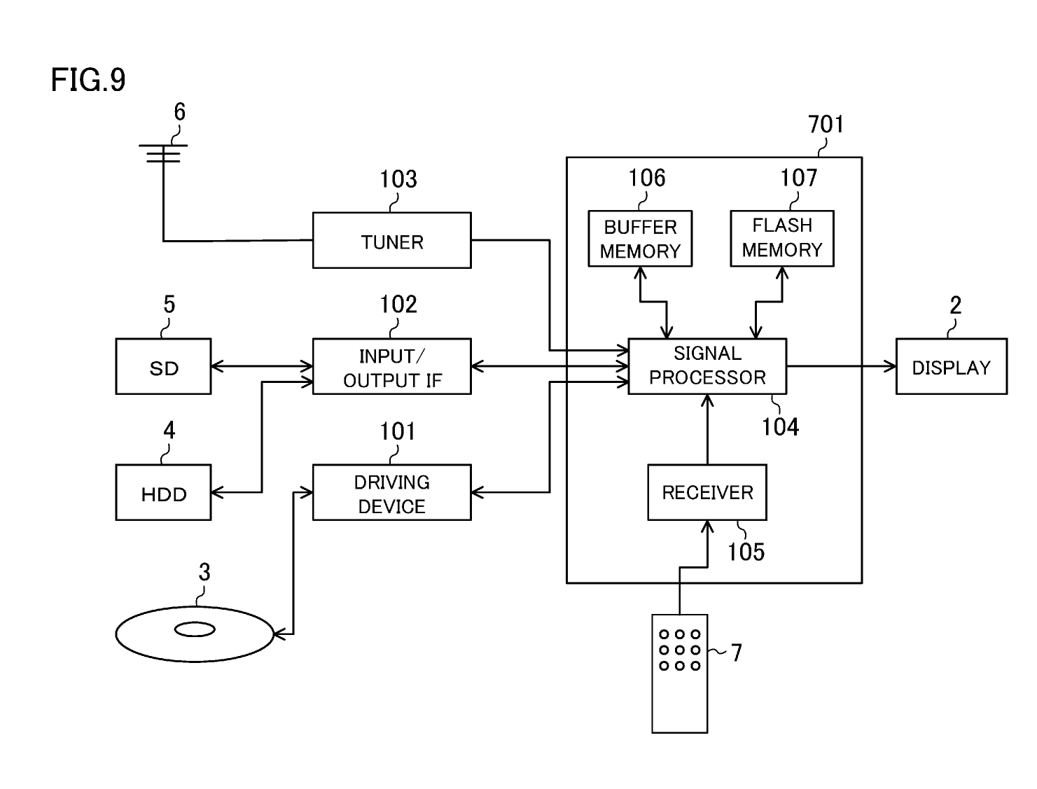

While in the above-described embodiments, the recording device 1 has been described as an example video processing device, the present disclosure is not limited thereto. For example, the video processing device may be a TV device including an antenna 6, a tuner 103, a signal processor 104, a receiver 105, a buffer memory 106, a flash memory 107, and a display 2. Alternatively, as shown in FIG. 9, the video processing device may be a video processing device 701 including a signal processor 104, a buffer memory 106, a flash memory 107, etc. In this case, a tuner 103, a BD disk 3, an HDD device 4, an SD card 5, etc. function as image input devices. Furthermore, a display 2 functions as an image display device.

The present disclosure includes the video processing method of the video processing device which has been described in the above embodiments. For example, the determiner 201 and the controller 204 may be included in a central processing unit (CPU), and the processing may be performed by using a program for operation in the CPU. Alternatively, the determiner 201 and the controller 204 may be included in a programmable logic device (PLD), and the processing may be performed by using a program for operating the PLD. The processing described in the above embodiments may be implemented by hardware, for example, an integrated circuit. For example, a module unit (a unit per board of an electrical signal circuit) etc. with the function of the signal processor 104 may be used.

Various embodiments have been described above as example techniques of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

The present disclosure is applicable to a video processing device allowing a viewer to suitably see an image in reproducing a compression coded stereoscopic image signal. Specifically, the present disclosure is applicable to video players, video cameras, digital cameras, personal computers, mobile phones with cameras, TVs, etc.

What is claimed is:

1. A video processing device reproducing a compression coded signal of a stereoscopic image, the device comprising:
a decoder configured to decode the compression coded signal into a stereoscopic image signal;
a determiner configured to evaluate a degree of a difference in an entire picture between a first viewpoint image and a second viewpoint image of the stereoscopic image signal decoded by the decoder, and to determine a display mode of the stereoscopic image signal based on the evaluation result; and
a picture generator configured to generate an output image according to the display mode determined by the determiner from the stereoscopic image signal.

2. The video processing device of claim 1, wherein
the determiner obtains encoding information contained in the compression coded signal from the decoder, and evaluates, based on the encoding information, a degree of an influence of compression distortion caused in compression coding on the stereoscopic image signal as an index indicating the degree of the difference.

3. The video processing device of claim 2, wherein
the determiner evaluates the degree of the influence of the compression distortion on the stereoscopic image signal using at least any one of a quantization width, a recording rate, information on setting a filtering degree of a deblocking filter, a ratio of intra/inter frame prediction blocks, or statistical information on a motion vector, which is contained in the encoding information.

4. The video processing device of claim 1, wherein
the determiner selects the display mode of the stereoscopic image signal from a plurality of display modes, and
the plurality of display modes at least includes
a first mode of outputting the stereoscopic image signal without change, and
a second mode of outputting the first viewpoint image of the stereoscopic image signal, and a new second viewpoint image newly generated from the first viewpoint image.

5. The video processing device of claim 4, further comprising:
a disparity image generator configured to generate disparity information from the first viewpoint image and the second viewpoint image of the stereoscopic image signal, and to generate the new second viewpoint image from the first viewpoint image based on the disparity information.

6. The video processing device of claim 1, wherein
the determiner determines the display mode when scenes of the stereoscopic image change.

7. A video processing method of reproducing a compression coded signal of a stereoscopic image, the method comprising:
decoding the compression coded signal into a stereoscopic image signal;
evaluating a degree of a difference in an entire picture between a first viewpoint image and a second viewpoint image of the decoded stereoscopic image signal, and determining a display mode of the stereoscopic image signal based on the evaluation result; and
generating an output image according to the determined display mode from the stereoscopic image signal.
